(19) United States
(12) Patent Application Publication
(10) Pub. No.: US 2008/0193020 A1
(43) Pub. Date: Aug. 14, 2008

(54) Method for Facial Features Detection

(75) Inventors: Alexander Sibiryakov, Surrey (GB); Miroslaw Bober, Surrey (GB)

Correspondence Address: BIRCH STEWART KOLASCH & BIRCH, PO BOX 747, FALLS CHURCH, VA, 22040-0747, US

(73) Assignee: Mitsubishi Electric Coporation, Tokyo (JP)

(21) Appl. No.: 11/884,702

(22) PCT Filed: Feb. 20, 2006
(86) PCT No.: PCT/GB2006/000591

§ 371 Date: Nov. 29, 2007

(30) Foreign Application Priority Data
Feb. 21, 2005 (EP) 05250970.0

(51) Int. Cl. G06K 9/00

(52) U.S. Cl. 382/209

(57) ABSTRACT

A method of detecting an object, in particular a face, in an image using template matching uses at least two different templates for the same object. Templates are provided for left eye, right eye and between-the-eyes. A confidence map is produced for each template and the confidence maps are merged. This may take place at several resolutions. The detected regions are further checked with symmetry, texture and/or geometrical relationship to other facial parts.

### The invention relates to a method and apparatus for detecting or locating objects, especially facial features, in an image.

Facial feature detection is a necessary first-step in many computer vision applications in areas such as face recognition systems, content-based image retrieval, video coding, video conferencing, crowd surveillance, and intelligent human-computer interfaces.

Given a typical face detection problem of locating a face in a cluttered scene, low-level analysis first deals with the segmentation of visual features using pixel properties such as gray-scale and color. Because of their low-level nature, features generated from this analysis are usually ambiguous. In feature analysis, visual features are organized into a more global concept of face and facial features using information about face geometry. Through feature analysis, feature ambiguities are reduced and the locations of the face and facial features are determined.

The gray-level information within an image is often used to identify facial features. Features such as eyebrows, pupils, and lips appear generally darker than their surrounding facial regions. This property can be exploited to differentiate various facial parts.

Several recent facial feature extraction algorithms (P. J. L. Van Beek, M. J. T. Reinders, B. Sankur, J. C. A. Van Der Lubbe, “Semantic Segmentation of Videophone Image Sequences”, in Proc. of SPIE Int. Conf. on Visual Communications and Image Processing, 1992, pp. 1182-1193; H. P. Graf, E. Cosatto, D. Gibson, E. Petajan, and M. Kocheisen, “Multi-modal System for Locating Heads and Faces”, in IEEE Proc. of 2nd Int. Conf. on Automatic Face and Gesture Recognition, Vermont, October 1996, pp. 277-282; and K. M. Lam and H. Yan) “Facial Feature Location and Extraction for Computerised Human Face Recognition”, in Int. Symposium on information Theory and Its Applications, Sydney, Australia, November 1994) search for local gray minima within segmented facial regions. In these algorithms, the input images are first enhanced by contrast-stretching and gray-scale morphological routines to improve the quality of local dark patches and thereby make detection easier. The extraction of dark patches is achieved by low-level gray-scale thresholding.

The paper, C. Wong, D. Kortenkamp, and M. Speich, “A Mobile Robot that Recognises People”, in IEEE Int. Conf. on Tools with Artificial Intelligence, 1995, describes the implementation of a robot that also looks for dark facial regions within face candidates obtained indirectly from color analysis. The algorithm makes use of a weighted human eye template to determine possible locations of an eye pair.

In R. Hoogenboom and M. Lew, “Face Detection Using Local Maxima”, in IEEE Proc. of 2nd Int. Conf. on Automatic Face and Gesture Recognition, Vermont, October 1996, pp. 334-339, local maxima, which are defined by a bright pixel surrounded by eight dark neighbors, are used instead to indicate the bright facial spots such as nose tips. The detection points are then aligned with feature templates for correlation measurements.

The work, G. Yang and T. S. Huang, “Human Face Detection in a Complex Background”, Pattern Recognition. 27, 1994, 53-63, on the other hand, explores the gray-scale behavior of faces in mosaic (pyramid) images. When the resolution of a face image is reduced gradually either by subsampling or averaging, macroscopic features of the face will disappear. At low resolution, the face region will become uniform. Based on this observation, a hierarchical face detection framework is proposed. Starting at low-resolution images, face candidates are established by a set of rules that search for uniform regions. The face candidates are then verified by the existence of prominent facial features using local minima at higher resolutions. This technique was incorporated into a system for rotation invariant face detection (X.-G. Lv, J. Zhou, and C.-S. Zhang, “A Novel Algorithm for Rotated Human Face Detection”, in IEEE Conference on Computer Vision and Pattern Recognition, 2000) and an extension of the algorithm is presented in C. Kotropoulos and I. Pitas, “Rule-based Face Detection in Frontal Views”, in Proc. Int. Conf. on Acoustic, Speech and Signal Processing, 1997.

The work, S. Kawato and N. Tetsutani, “Real-time Detection of Between-the-Eyes with a Circle Frequency Filter”, ACCV2002: The 5th Asian Conference on Computer Vision, Melbourne, 2002, claims that the point between the eyes is common to most people, and it can be seen for a wide range of face orientations. Moreover, the pattern around this point is fairly stable for any facial expression. The authors propose an algorithm for detection of this feature based on their circle-frequency filter. After detecting the point between eyes the task of nearby facial feature detection is simplified significantly, and this idea is used in our proposal.

U.S. Pat. No. 6,690,814 is concerned with face and facial feature detection from image sequences. The face detection task is simplified by a special arrangement of camera position when a new face image is compared to previously recorded background image. Using image subtraction and thresholding the the face region is located and facial features such as eyes are extracted as dark regions in face region. Special matched filters of different sizes are applied to dark regions. A particular size of filter whose output value is maximum is regarded as the size of the pupil. After filtering, the filter output is smoothed by a Gaussian filter, and the resulting local maxima are pupil candidates. Special arrangement of the camera position restricts possible applications of this method. In our proposal we do not rely on any predefined camera position.

U.S. Pat. No. 6,681,032 describes a face recognition system containing face and eye detection modules. The main difference of this method from the proposed method is that the face detection method is entirely based on extracting skin color distribution and matching it with pre-stored information. The eye detection module is based on matching region of interest with eigeneye templates, constructed from a reference set of images.

U.S. Pat. No. 6,611,613 contains an eye detection method based on the observation that eye regions of the face image commonly contain a strong gray characteristic (small difference between the maximum and minimum values of color components). The extracted regions are then validated by geometrical features (compactness, aspect ratio) and by texture features (presence of strong horizontal edges). The extracted eye pair determines the size, orientation and position of the face region, which is further validated by other facial features (eyebrows, nostrils, mouth).

U.S. Pat. No. 6,381,345 describes an eye detection method suitable for videoconference applications. First the image is blurred using a Gaussian filter, then eyes are extracted as large dark regions, then eyebrows are eliminated using geometrical features. After that the eyes are segmented using brightness thresholding, and their parameters are determined. The main difference between this method and our proposal is that it assumes that the face is always located in the center of the image and only one eye pair is extracted. Also it uses a predetermined set of brightness thresholds, which was found to be difficult to use under different lighting conditions.

The method from U.S. Pat. No. 6,151,403 consists of the following steps, which are different from our method: (a) determining potential skin regions in an image, based on color; (b) determining valley regions inside the skin region, using morphological operations; (c) template matching, using cross-correlation applied in the valley regions.

The method of eye detection described in U.S. Pat. No. 6,130,617 comprises the steps of: binarizing a face image, extracting candidate regions existing in pairs, determining one candidate pair among all pairs as nostrils, setting the remained candidate pairs forming equilateral triangles in relation to the nostrils as eye candidate pairs, and determining a candidate pair forming the smaller equilateral triangle as eyes. This approach is based on detection of nostrils as the primary facial feature. It was found that this feature is stable only under a special arrangement of camera orientation (upward direction of the optical axis). In our proposal the between-eyes region is used as the primary facial feature; this feature is stable for different face and camera orientations.

U.S. Pat. No. 5,870,138 describes a method of using HSV color space for face and facial features detection. Only H and S components are used for face region detection. The mouth is detected from S and V components using a band pass filter within the face region. The V component within the face region is normalized and correlation with an eye template is used to locate the eyes. Region tracking is used to reduce the search area.

U.S. Pat. No. 5,715,325 describes a system for person identification, where eye features are used in the final stage of face detection. First, the image is reduced in resolution and normalized to compensate for lighting change. Then it is compared to a pre-stored background image to produce a binary interest mask. The face region is determined by template matching and if the matching score exceeds a threshold; a further eye location procedure based on a neural network is performed.

U.S. Pat. Nos. 6,278,491 and 5,990,973 describe red-eye detection and reduction methods. The main purpose of these methods is to automatically find red eyes resulting from using flash in digital photography. While these methods include face and eye detection steps, their main drawback is that they work well only with color and high-resolution digital images. The unique feature, the red pupil, is used for eye detection. Also, these methods are designed for post-processing of single digital photographs and may not be suitable for real-time video processing due to using computationally expensive algorithms (for example, multi-scale and multi-rotational template matching).

The problem addressed by this invention is robust facial feature detection in complex environments, such as low-quality images and cluttered backgrounds.

One problem of the existing methods of eye detection is their complexity and low reliability due to search of consistent region pairs (left eye, right eye) in the image. Even in a simple image many candidate region pairs can be found and this ambiguity should be resolved by higher-level decision rules. In the present specification, the eye detection is based on a feature that is not frequent in an image. This feature is a region triplet containing left eye, between eyes and right eye regions. This region triplet is further validated by the presence of other facial feature regions such as the mouth, so that eye detection becomes much less ambiguous and less time-consuming.

Aspects of the invention are set out in the accompanying claims. The invention involves processing signals corresponding to images, using a suitable apparatus.

The solution proposed according to an embodiment of the invention involves the following steps:

1. Facial feature template design and simplification. The template represents only the general appearance of a facial feature, as a union of dark and light regions. Each facial feature can have a set of different templates.

2. Low-level image processing stage:

Image transformation to integral images so that the time required by the subsequent template matching is independent of template size.

Template matching on a pixel-by-pixel basis, resulting in multiple confidence maps for each facial feature.

Combination of confidence maps and extraction of facial feature regions with high confidence level.

3. Facial feature analysis and selection stage:

Region arrangement analysis and extraction of multiple sets of candidates for ‘left eye’, ‘between eyes’, ‘right eye’.

Best facial feature candidates selection based on high confidence levels, texture features and presence of other facial feature regions

4. Hierarchical strategy of facial feature detection:

Application of steps 1,2 to downsampled versions of the image and templates

Extraction of Region Of Interest (ROI) containing detected facial features

Application of steps 1,2 to the original versions of the templates and the image inside the ROI to exactly locate the facial features.

Combining the results from different resolutions. If the method fails in one of the resolutions then the results from other resolutions are used.

Further aspects of the invention include the following:

1. Using any number of templates for each facial feature in an unified framework.

2. Using four specific templates (‘between eyes region’, ‘horizontal facial feature’ and ‘open eye’) shown in FIG. 2

3. A method for template matching based on statistical data analysis and signal-to-noise ratio computation.

4. Using a stable region triplet <Left Eye, Between Eyes, Right Eye> as the main feature of a face region

5. A method for best facial feature candidate selection based on high confidence levels, texture features and presence of other facial feature regions.

The proposed method has some important and useful properties. Firstly, it describes an approach to facial feature template design and simplification allowing real-time processing. Secondly, a low-cost real-time extension of the template matching method is achieved by using the known integral images technique.

An embodiment of the invention will be described with reference to the accompanying drawings of which:

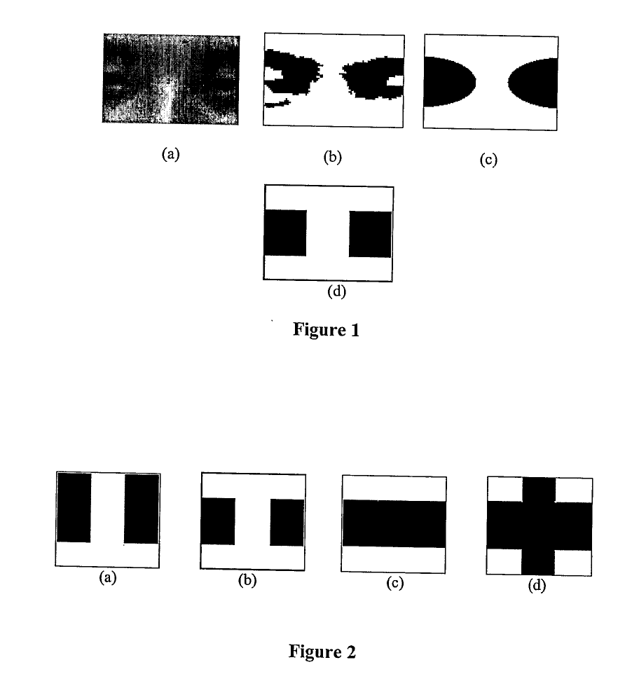

FIG. 1a shows an image of a facial feature;

FIG. 1b shows a binary version of the image of FIG. 1a;

FIGS. 1c and 1d show templates for the facial feature of FIG. 1a;

FIGS. 2a to 2d are templates for other facial features;

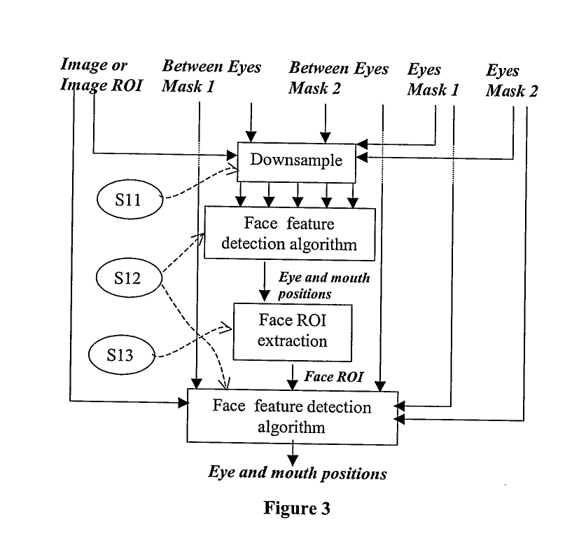

FIG. 3 is a block diagram illustrating a method of detecting facial features;

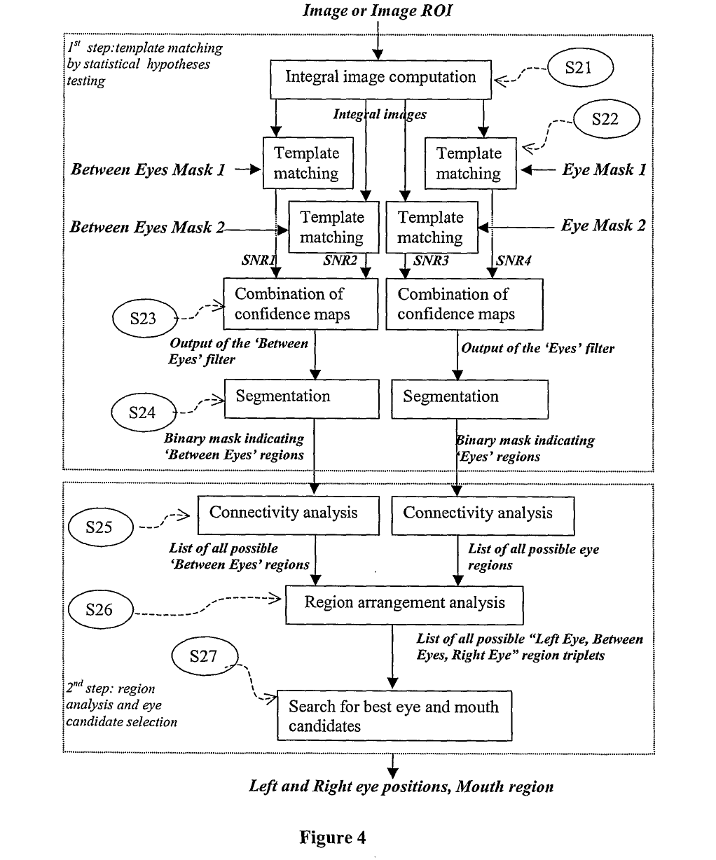

FIG. 4 is a block diagram illustrating a facial feature detection algorithm;

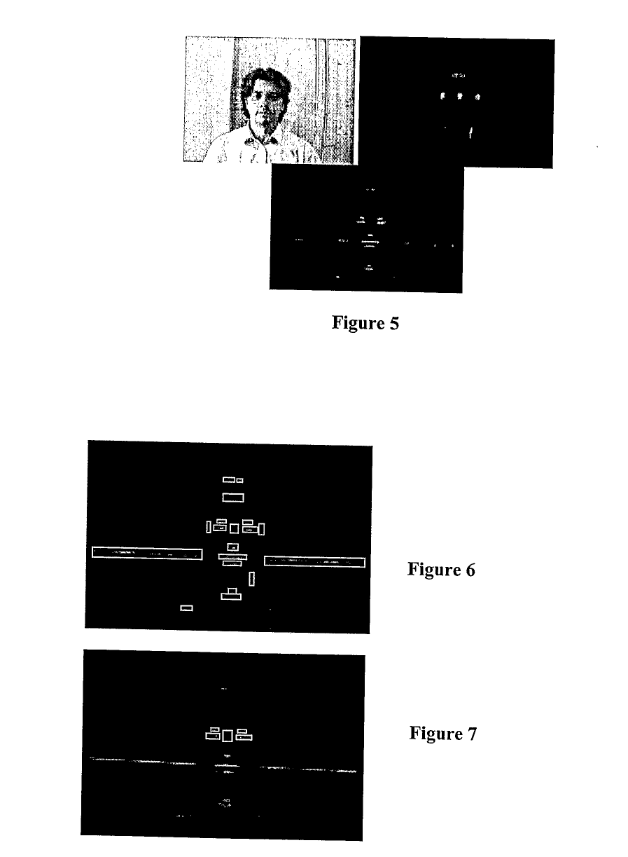

FIG. 5 includes an original image and corresponding images showing the results of template matching;

FIG. 6 is an image showing the result of connected region labeling of the thresholded confidence map, composed of multiple template matching results;

FIG. 7 is an image showing the result of triplet feature detection;

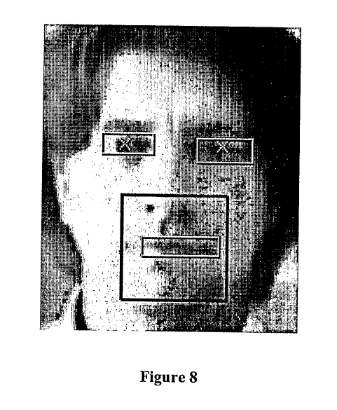

FIG. 8 is an image illustrating feature detection;

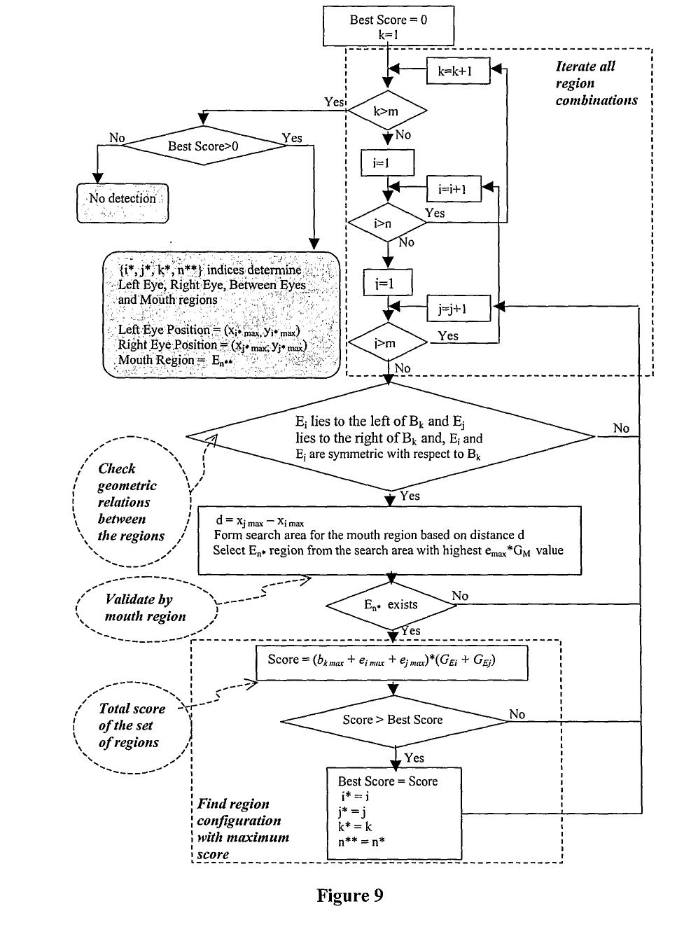

FIG. 9 is a block diagram illustrating a region analysis and facial feature selection algorithm based on confidence maps, region symmetry and texture measurements.

The general appearance of a facial feature of interest is encoded by simple templates (FIGS. 1 and 2). The template consists of regions, showing where the distribution of pixel values is darker (black regions) or lighter (white regions). For qualitative estimation of the region shapes a binarization method can be used. FIGS. 1a and 1b show an image with a facial feature of interest (between-eyes region) and the corresponding binarization, for qualitative estimation of a template shape. In the example in FIG. 1, the feature of interest (between eyes region) looks like two dark elliptical regions (see the template in FIG. 1c derived from the binarized image in FIG. 1b). Due to real-time processing requirements all the regions are preferably rectangular. This leads to further simplification of the template, shown in FIG. 1(d).

Two different templates for the between eyes region are shown in FIG. 2(a)(b).

In the following text and block-schemes these templates are referred to as ‘Between Eyes Mask 1’ and ‘Between Eyes Mask 2’. The horizontal facial features template, shown in FIG. 2(c), serves to detect closed eyes, mouth, nostrils, and eyebrows. The template in FIG. 2(d) is specially designed for open eye detection (dark pupil in light neighbourhood). In the following text and block-schemes the templates from FIGS. 2(c)(d) are also referred to as ‘Eye Mask 1’ and ‘Eye Mask 2’ respectively.

The templates shown in FIG. 2 are simplified templates; they represent only the general appearance of each facial feature, as a union of dark and light regions (rectangles).

The block-scheme and data flow of the hierarchical method for facial features detection is shown in FIG. 3.

First, the original image and all templates are downsampled (S11). For speed reasons, averaging of four neighbor pixels and image shrinking by a factor of 2 is used, but any other image resizing method can be used. To downsample the templates, the coordinates of their rectangles are divided by 2 and rounded up or down to the nearest integer value.

In the next step S12 the facial feature detection algorithm is applied to downsampled versions of the image and templates. This reduces computational time by a factor of four, but also may reduce the accuracy of facial feature positions. Often eyes can be more easily detected in the downsampled images because confusing details, such as glasses, may not appear at the reduced resolution. The opposite situation is also possible: eyebrows at lower resolution can look like closed eyes and closed eyes can almost disappear; in this case the eyebrows usually become the final result of detection. If a mouth can be detected at the original resolution then it can usually also be detected at lower resolution. This means that even if eyebrows are detected instead of eyes, the face region, containing eyes and mouth, is detected correctly.

Taking into account possible problems with detection results at lower resolution, the detected features are used only for extraction of Region Of Interest (S13).

Finally, the same detection algorithm is applied to original resolution of templates and the image inside the ROI to exactly locate the facial features (S12). Some results from the detection at lower resolution, such as approximate mouth position, can be used in this step. The computational time of this step is proportional to the ROI size, which is usually smaller than the size of the original image.

The block-scheme and data flow of the facial feature detection algorithm (denoted by S12 in FIG. 3) is shown in FIG. 4. There are two main steps in the algorithm; the first one is a low-level image processing, including:

1) Integral image computation (S21). As the templates are represented as a union of rectangles of different sizes, a special image pre-processing is required for fast computation of statistical features (average and dispersion) inside these rectangles. Transformation of the image into the integral representation provides fast computation of such features with only four pixel references, i.e. the corners of the rectangles. Integral image computation is a known prior art technique. Briefly, it involves integral images Sum(x,y) and SumQ(x,y) defined as follows:

$$Sum ( x , y ) = {\sum }_{a \leq x} {\sum }_{b \leq y} I ( a , b ) = I ( x , y ) + S ( x - 1 , y ) + S ( x , y - 1 ) - S ( x - 1 , y - 1 )$$

$$Sum Q ( x , y ) = {\sum }_{a \leq x} {\sum }_{b \leq y} {I}^{2} ( a , b ) = {I}^{2} ( x , y ) + S Q ( x - 1 , y ) + S Q ( x , y - 1 ) - S Q ( x - 1 , y - 1 ) \\$$

where I(x,y) is the original image for x,y≧0 and I(x,y)=0 for x,y<0.

2) Template matching performed for each template (S22). This procedure is based on statistical hypothesis testing for each pixel neighbourhood. The result of this step is a set of confidence maps. Two maps indicate a likelihood of presence of the ‘Between Eyes’ region; another two maps indicate possible eye regions. Each pixel of a confidence map contains a result of hypothesis testing and can be considered as a similarity measure between the image region and a template.

3) Combination of confidence maps (S23). Pixel-by-pixel multiplication of confidence maps is used in the current implementation, but other combination methods, such as addition or maximal value selection, are also applicable. The range of pixel-by-pixel multiplication results depends on numerical format of the confidence maps. In the case of fixed-point representation, additional division or bit shift is required.

4) Segmentation of confidence maps (S24). Each confidence map is segmented in order to separate regions with high confidence from the background of low confidence. The similarity measure can be also interpreted as signal-to-noise ratio (SNR), which opens the possibility of thresholding the confidence map. A threshold value of SNR˜1.1, indicating that the signal level is just above the noise level, is used in the current implementation. More sophisticated methods of segmentation, such as morphological operations or small/large region elimination are also applicable at this stage.

The second step of the algorithm consists of analysis aiming to detect image regions with a high confidence value. First, all such regions are extracted by a connected component labelling algorithm (S25) applied to thresholded confidence maps. Then all possible region triplets (Left Eye region, Between Eyes region, Right Eye region) are iterated and roughly checked for symmetry (S26). And finally, the triplets with high total confidence level, validated by texture features and the presence of other facial feature regions such as mouth and nostrils, are selected (S27). Local maxima of confidence level are considered as exact eye positions.

Template matching in the preferred embodiment is carried out as follows.

Application of the statistical t-test to two pixel groups from the image, defined by a template (FIG. 2) leads to the following similarity measure (some equivalent transformations are skipped):

$${( \frac{Signal}{Noise} )}^{2} = {( \frac{Difference between group means}{Variability of groups} )}^{2} = \frac{\vert R \vert {σ}^{2} ( R )}{\vert B \vert {σ}^{2} ( B ) + \vert W \vert {σ}^{2} ( W )} - 1$$

Removing the constant from the expression above we obtain our similarity measure:

$$S N R = \frac{\vert R \vert {σ}^{2} ( R )}{\vert B \vert {σ}^{2} ( B ) + \vert W \vert {σ}^{2} ( W )}$$

where the template R is represented as union of two regions: R=B∪W, where B is a ‘black’ region; W is a ‘white’ region; ρ²(Q) is the dispersion of the image values in region Q, and |Q| designates the number of pixels inside region Q. Using the integral images the computation of σ²(Q) for any rectangular region Q requires 2*4 pixel references instead of 2*|Q|. Pixel referencing here means single addressing to a 2D image array in a memory in order to obtain a pixel value.

FIG. 5 shows results of template matching for ‘Between eyes’ and ‘Eye’ templates.

FIG. 6 shows a set of regions extracted from the confidence maps, and the result of connected region labelling applied to the result of combining two confidence maps for both ‘Between Eyes’ and ‘Eyes’ templates. Each region is shown by its bounding box. FIG. 7 shows the result of region arrangement analysis based on symmetry. This result contains candidates for Left Eye, Between Eyes, Right Eye features. We assume that the distance between left and right eyes is approximately equal to the distance between the mouth and the middle of the eyes. Having two eye candidates a rectangular search area of dimension d×d is determined, where d is the distance between the eye positions. The vertical distance between this region and eyes is chosen to be d/2. A region in the search area, containing the highest confidence map value, is selected as a candidate for the mouth region (FIG. 8).

Using the results of template matching and connected region labelling the algorithm selects the best eye candidates based on high confidence map values, region symmetry and high gradient density. To select the correct set of regions corresponding to left eye, between eyes, right eye and mouth the algorithm shown in FIG. 9 is used.

The following designations are used in FIG. 9:

b(x,y) is ‘between eyes’ confidence map;

B={B₁, . . . , Bₙ} is a set of connected regions extracted from b(x,y).

e(x,y) is ‘eyes’ confidence map;

E={E₁, . . . , Eₘ} is a set of connected regions extracted from e(x,y). Note that the E set includes both eyes and mouth candidate regions.

i,j,k indices specify current left eye, right eye and between eyes regions respectively.

For each region from the B set the position of the maximum and its value bₘₐₓ(x_{max,}yₘₐₓ) are pre-computed; bₘₐₓ is used to compute the total score of the set of regions (FIG. 9); (x_{max,}yₘₐₓ) indicates the centre of each possible between-eyes region.

Each region from the E set has the following pre-computed features:
eₘₐₓ(x_{max,}yₘₐₓ)—position of the maximum and its value; eₘₐₓ is used to compute the total score of the set of regions (FIG. 9); (x_{max,}yₘₐₓ) indicates an eye centre.
G_{E}, G_{M}—texture measurements, which are computed inside a region P as follows:

$${G}_{E} = \frac{1}{\vert P \vert} {\sum }_{( x , y ) ε P} \vert I ( x + 1 , y ) - I ( x , y ) \vert , \\ {G}_{M} = \frac{1}{\vert P \vert} {\sum }_{( x , y ) ε P} \vert I ( x , y + 1 ) - I ( x , y ) \vert$$

Both texture measurements contribute to the total score of the region set (FIG. 9).

Some alternatives and developments are discussed below.

Detection of other facial features, such as nose and nostrils, was also considered in order to support detection of the main facial features. This implementation can restrict the range of situations where the method works stably, because appearance of these facial features is more affected by lighting conditions and camera position. But in some specific applications, such as videoconferences, including these features makes the system more robust.

Colour-based skin segmentation can significantly restrict the search area in the image and reduce the number of candidates for facial features. This implementation can also restrict the range of situations where the method can work (greyscale images, poor lighting conditions).

Tracking of face and facial features has been implemented as an option (see FIGS. 3, 4 where instead of the image an arbitrary image ROI can be used)). This mode significantly reduces computational time, but it is not suitable for processing single images.

In this specification, the term “image” is used to describe an image unit, including after processing such as to change resolution, upsampling or downsampling or in connection with an integral image, and the term also applies to other similar terminology such as frame, field, picture, or sub-units or regions of an image, frame etc. The terms pixels and blocks or groups of pixels may be used interchangeably where appropriate. In the specification, the term image means a whole image or a region of an image, except where apparent from the context. Similarly, a region of an image can mean the whole image. An image includes a frame or a field, and relates to a still image or an image in a sequence of images such as a film or video, or in a related group of images.

The image may be a grayscale or colour image, or another type of multi-spectral image, for example, IR, UV or other electromagnetic image, or an acoustic image etc.

The invention can be implemented for example in a computer system, with suitable software and/or hardware modifications. For example, the invention can be implemented using a computer or similar having control or processing means such as a processor or control device, data storage means, including image storage means, such as memory, magnetic storage, CD, DVD etc, data output means such as a display or monitor or printer, data input means such as a keyboard, and image input means such as a scanner, or any combination of such components together with additional components. Aspects of the invention can be provided in software and/or hardware form, or in an application-specific apparatus or application-specific modules can be provided, such as chips. Components of a system in an apparatus according to an embodiment of the invention may be provided remotely from other components, for example, over the internet.

This application is related to our co-pending application entitled “Fast Method Of Object Detection By Statistical Template Matching” filed on the same date, the contents of which are incorporated herein by reference. Further details of certain aspects of the embodiment described herein, such as statistical template matching and derivation and use of the integral image, can be found in the above co-pending application.

1. A method of detecting an object in an image using template matching, characterised by using at least two different templates for the same object.

2. The method of claim 1 comprising combining the results of the template matching for each of the at least two different templates for an object.

3. The method of claim 1 or claim 2 comprising deriving a plurality of confidence maps each relating to the result of template matching for the same object.

4. The method of any preceding claim comprising downsampling the original image, performing template matching using the downsampled image to detect regions possibly containing the object of interest and performing template matching of the original image for said regions possibly containing the object of interest.

5. The method of claim 4 comprising combining results for different resolutions.

6. The method of any preceding claim comprising performing template matching at a plurality of resolutions, and deriving a plurality of confidence maps for different resolutions.

7. The method of claim 3 or claim 6, comprising combining the confidence maps.

8. The method of any of claims 2, 5 or 7 wherein combining involves pixel by pixel multiplication, addition, maximal value selection or the like, optionally followed by thresholding and morphological post-processing.

9. The method of any preceding claim comprising performing connectivity analysis, for example on the binary image resulting from the method of claim 8.

10. The method of any preceding claim comprising performing region arrangement analysis.

11. The method of claim 10 wherein region arrangement analysis involves symmetry checking.

12. The method of any preceding claim comprising combining results of template matching with one or more of texture information and information about other objects in the image.

13. The method of any preceding claim for detecting one or more facial features.

14. The method of claim 13 wherein the template matching includes matching left eye, right eye and between eyes regions.

15. A method of detecting facial features in an image using template matching, comprising using template matching for the features of left eye, right eye and between eyes.

16. The method of claim 14 or claim 15 comprising using one or more templates for each of the features of left eye, right eye and between eye respectively.

17. The method of any of claims 14 to 16 comprising using templates of the form of or similar to those in FIG. 2.

18. The method of any of claims 14 to 17 comprising validating a region triplet of left eye, right eye and between eyes by the presence of a mouth region.

19. The method of any of claims 13 to 18 comprising using templates for both a closed eye and an open eye.

20. A method of selecting a facial region candidate in an image comprising considering a region triplet of left eye, right eye and between eyes, and validating the region triplet using a mouth region.

21. Apparatus for executing the method of any preceding claim.

22. A control device programmed to execute the method of any of claims 1 to 20.

23. Apparatus comprising the control device of claim 22, and storage means for storing images.

24. A computer program, system or computer-readable storage medium for executing a method of any of claims 1 to 20.
